(19) United States
(12) Patent Application Publication
(10) Pub. No.: US 2026/0169661 A1
(43) Pub. Date: Jun. 18, 2026

(54) MANAGEMENT METHOD, MANAGEMENT APPARATUS, AND STORAGE MEDIUM

(71) Applicant: Konica Minolta, Inc., Tokyo (JP)

(72) Inventor: Tetsuren NOGAWA, Tokyo (JP)

(21) Appl. No.: 19/416,895

(22) Filed: Dec. 11, 2025

(30) Foreign Application Priority Data
Dec. 13, 2024 (JP) 2024-218534

(51) Int. Cl. G06F 3/12; G06K 15/00

(52) U.S. Cl. CPC G06F 3/1208; G06F 3/1229; G06K 15/4065

(57) ABSTRACT

A management method is performed by a management apparatus that manages an image forming apparatus, and includes acquiring environment information on the image forming apparatus in a period including a state in which the image forming apparatus is not executing a print job, and presenting the acquired environment information in time series.

### CROSS-REFERENCE TO RELATED APPLICATION

The entire disclosure of Japanese Patent Application No. 2024-218534, filed on Dec. 13, 2024, including description, claims, drawings and abstract is incorporated herein by reference.

### BACKGROUND OF THE INVENTION

### Technical Field

The present disclosure relates to a management method, a management apparatus, and a storage medium.

### Description of Related Art

A conveyance error, such as a jam, related to conveyance of a sheet and an image error related to image quality in an image forming apparatus are strongly correlated with conditions of the sheet, such as humidity and temperature. Therefore, changes in humidity and temperature at a production site have various effects on the printing operation and the production workflow. An example of a technology for detecting temperature and humidity in an image forming apparatus is disclosed in Japanese Unexamined Patent Publication No. 2009-276409. Japanese Unexamined Patent Publication No. 2009-276409 describes an image forming apparatus that creates environment history information based on an output of a detection means for detecting temperature or humidity, and transmits the environment history information as a material for determining whether to change a setting value of an image defect elimination control means.

### SUMMARY OF THE INVENTION

However, such a conventional technology visualizes environment information, such as temperature and humidity, during execution of a print job, but does not visualize environment information when an image forming apparatus is not executing a print job. In this case, since changes in environment information such as the overall temperature and humidity cannot be grasped, there is a problem that an optimum printing operation and production workflow cannot be determined and implemented.

Therefore, in order to solve the above-described problem, an object of the present disclosure is to provide a management method, a management apparatus, and a storage storing a program each capable of visualizing environment information on an image forming system in a period including a state where a print job is not being executed.

To achieve at least one of the abovementioned objects, according to an aspect of the present disclosure, a management method reflecting one aspect of the present disclosure is performed by a management apparatus that manages an image forming apparatus, and includes:
acquiring environment information on the image forming apparatus in a period including a state in which the image forming apparatus is not executing a print job; and
presenting the acquired environment information in time series.

### BRIEF DESCRIPTION OF THE DRAWINGS

The advantages and features provided by one or more embodiments of the present disclosure will become more fully understood from the detailed description given hereinafter and the appended drawings which are given by way of illustration only, and thus are not intended as a definition of the limits of the present disclosure, and wherein:

FIG. 1 is a diagram showing an example of a schematic configuration of a printing system according to the present embodiment;

FIG. 2 is a diagram illustrating an example of a schematic configuration of a first image forming system according to the present embodiment;

FIG. 3 is a block diagram of the first image forming system according to the present embodiment;

FIG. 4 is a block diagram of a printer controller according to the present embodiment;

FIG. 5 is a block diagram of a client terminal according to the present embodiment;

FIG. 6 is a block diagram of a management apparatus according to the present embodiment;

FIG. 7 is a flowchart illustrating an example of the operation of the management apparatus that manages environment information on the image forming system according to the present embodiment;

FIG. 8 is a diagram illustrating an example of a first environment information image displayed on a display part of the client terminal according to the present embodiment;

FIG. 9 is a diagram illustrating an example of a second environment information image displayed on the display part of the client terminal according to the present embodiment;

FIG. 10 is a diagram illustrating an example of a third environment information image displayed on the display part of the client terminal according to the present embodiment;

FIG. 11 is a diagram illustrating an example of a fourth environment information image displayed on the display part of the client terminal according to the present embodiment;

FIG. 12 is a diagram illustrating an example of a fifth environment information image displayed on the display part of the client terminal according to the present embodiment;

FIG. 13 is a diagram illustrating an example of a sixth environment information image displayed on the display part of the client terminal according to the present embodiment; and

FIG. 14 is a diagram illustrating an example of a seventh environment information image displayed on the display part of the client terminal according to the present embodiment.

### DETAILED DESCRIPTION

Hereinafter, one or more embodiments of the present disclosure will be described with reference to the drawings. However, the scope of the present disclosure is not limited to the disclosed embodiments.

Below, with reference to the accompanying drawings, a management method, a management apparatus, and a storage medium storing a program according to preferred embodiments of the present disclosure will be described in detail.

### Configuration Example of Printing System 1

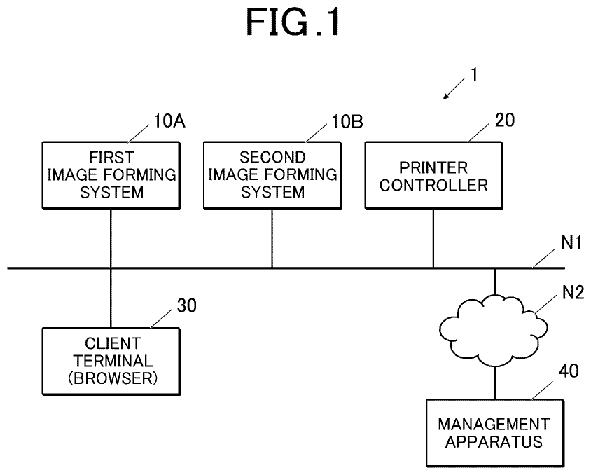

FIG. 1 is a diagram illustrating an example of a schematic configuration of a printing system according to the present embodiment. As illustrated in FIG. 1, the printing system 1 includes a first image forming system 10A, a second image forming system 10B, a printer controller 20, a client terminal 30, and a management apparatus 40. Note that the first image forming system 10A, the second image forming system 10B, the printer controller 20, the client terminal 30, and the management apparatus 40 each may not be sigle as illustrated in FIG. 1 but may be plural.

The first image forming system 10A, the second image forming system 10B, the printer controller 20, and the client terminal 30 are communicably connected to each other via a first network N1. Examples of the first network N1 include wired LANs and wireless LANs such as Wi-Fi. The LAN is an abbreviation for Local Area Network. The first image forming system 10A and the like and the management apparatus 40 are communicably connected to each other via a second network N2. Examples of the second network N2 include the Internet, a WAN, a telephone line network, and the like. The WAN is an abbreviation for Wide Area Network.

The first image forming system 10A and the second image forming system 10B form a predetermined image on a sheet S based on image data transmitted from the printer controller 20, and then perform predetermined post-processing on the sheet S after the image formation processing. The first image forming system 10A or the like detects environment information or the like in a period including a state in which a print job is not being executed, and transmits the environment information or the like to the management apparatus 40. The state in which the image forming system 10A or the like is not executing a print job refers to, for example, a state in which the image forming system 10A or the like has shifted to standby or sleep, or a printing standby state during non-execution of a print job before shifting to sleep or the like. The environment information includes at least one of temperature and humidity. Note that hereinafter, the first image forming system 10A and the second image forming system 10B are systems having the same configuration and function, and therefore, only the first image forming system 10A will be described as a representative in some cases. Furthermore, the plurality of image forming apparatuses including the first image forming system 10A and the second image forming system 10B may be collectively referred to as an image forming system 10.

The printer controller 20 analyzes a print job received from the client terminal 30 or the like via the first network N1, and executes RIP processing such as color conversion, screening, and rasterizing. The RIP is an abbreviation for Raster Image Processor. The printer controller 20 transmits image data generated by the RIP processing to the first image forming system 10A, the second image forming system 10B, and the like via the first network N1.

The client terminal 30 is, for example, a personal computer, a tablet, or a smartphone. A printer driver for converting document data into a print job is installed in the client terminal 30. The printer driver generates a print job in a format compatible with the printer controller 20, and sends the print job to the printer controller 20 via the first network N1. Further, the client terminal 30 can display an environment information image including a two-dimensional chart (graph), a table, and/or the like where changes in environment information in the first image forming system 10A or the like are visualized in time series. Note that the client terminal 30 may be connected to the second network N2 or the like different from the first network N1.

The management apparatus 40 is, for example, a computer including a cloud server, and manages the first image forming system 10A and the second image forming system 10B. Note that the target managed by the management apparatus 40 is not limited to the two image forming systems, namely, the first image forming system 10A and the second image forming system 10B, but may be one image forming system 10 or three or more image forming systems 10. The management apparatus 40 acquires and stores environment information or the like on the first image forming system 10A or the like in the period including the state where the first image forming system 10A or the like is not executing a print job. The management apparatus 40 presents, to an external apparatus, an environment information image or the like where the environment information acquired from the first image forming system 10A or the like is visualized in time series. Examples of the external apparatus include the client terminal 30, the first image forming system 10A, and the second image forming system 10B. Furthermore, besides the client terminal 30 and the like, the external apparatus may be a display device that is connected to the management apparatus 40, an information processing apparatus (not illustrated) that is connected to the second network N2, or the like.

### Configuration Example of First Image Forming System 10A

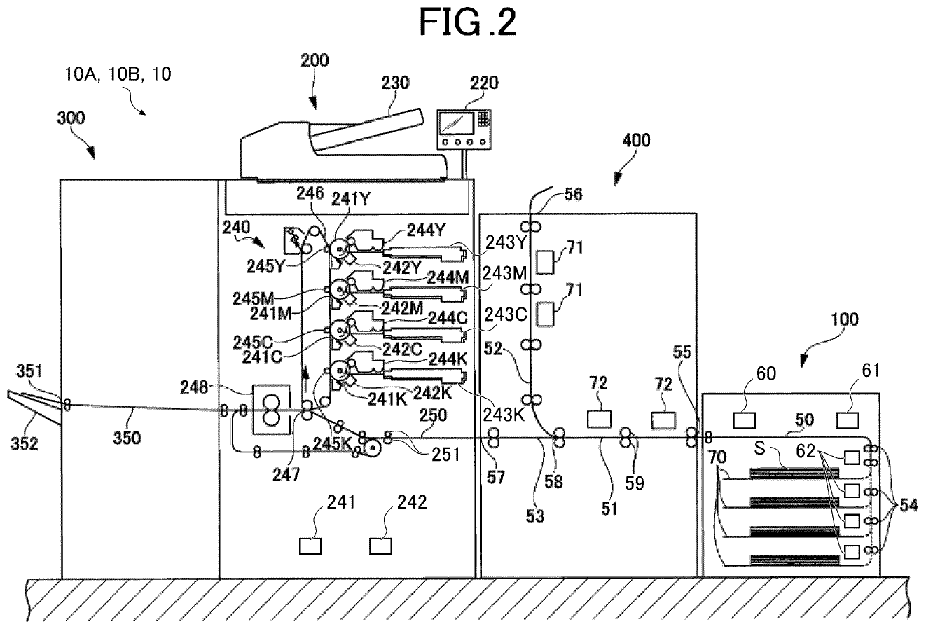

FIG. 2 is a diagram illustrating an example of a schematic configuration of the image forming system 10A according to the present embodiment. The image forming system 10 includes a sheet feed device 100, a sheet conveyance device 400, an image forming apparatus 200, and a post-processing device 300.

### (Sheet Feed Device 100)

The sheet feed device 100 stores sheets S for image formation and feeds the sheets S to the image forming apparatus 200 in accordance with a print job. As illustrated in FIG. 2, the sheet feed device 100 includes a sheet feed section 70, a conveyance section 50, a temperature detector 60, a humidity detector 61, and a remaining amount sensor 62.

The sheet feed section 70 includes, for example, a plurality of sheet feed trays and the like disposed in the sheet feed device 100. The sheet feed section 70 can load a plurality of sheets S in a stacked state. Although FIG. 2 illustrates an example of a configuration including four sheet feed trays arranged in the vertical direction, the number of sheet feed trays may be one or may be plural other than four. Sheets of different types and sizes can be accommodated in the sheet feed trays of the sheet feed sections 70.

The conveyance section 50 includes a pickup roller (not illustrated) to pick up a sheet from each sheet feed section 70, a plurality of conveyance rollers 54 provided along a predetermined sheet conveyance route to convey the sheet, and the like. The conveyance route of the conveyance section 50 join together from the plurality of sheet feed sections 70 and are connected to the sheet conveyance device 400. Thus, the conveyance section 50 can convey a sheet S fed from the sheet feed section 70 to the sheet conveyance device 400 by driving the conveyance roller 54.

The temperature detector 60 is installed in the sheet feed device 100, and detects the temperature in the sheet feed device 100 in the period including the state where the first image forming system 10A is not executing a print job. The temperature detector 60 is composed of, for example, a thermocouple, a thermistor, a thermopile or the like.

The humidity detector 61 is installed in the sheet feed device 100, and detects the humidity in the sheet feed device 100 in the period including the state where the first image forming system 10A is not executing a print job. The humidity detector 61 is composed of, for example, a resistance sensor or a capacitance sensor.

The remaining amount sensor 62 is installed, for example, in each of the plurality of sheet feed trays, and detects the remaining amount of sheets S in the sheet feed tray in the period including the state where the image forming system 10A is not executing a print job. The remaining amount sensor 62 is composed of, for example, an infrared rays sensor or a weight sensor.

### (Sheet Conveyance Device 400)

The sheet conveyance device 400 detects sheet characteristics of the sheet S conveyed from the sheet feed device 100. The sheet conveyance device 400 includes a first conveyance section 51, a second conveyance section 52, a third conveyance section 53, a first detector 71, and a second detector 72. The first detector 71 and the second detector 72 correspond to examples of a sheet characteristic detector.

The first conveyance section 51, the second conveyance section 52, and the third conveyance section 53 each include a plurality of conveyance rollers 59 and the like for conveying a sheet S along a conveyance route constituting each conveyance section. On the upstream side of the first conveyance section 51 in the sheet conveyance direction, an inlet port 55 for conveying a sheet S from the sheet feed device 100 to the sheet conveyance device 400 is provided. On the downstream side of the first conveyance section 51 in the sheet conveyance direction, a branch portion 58 is provided for branching the conveyance route of the sheet S into the second conveyance section 52 and the third conveyance section 53. The first conveyance section 51 forms a conveyance route between the inlet port 55 and the branch portion 58.

On the downstream side of the second conveyance section 52 in the sheet conveyance direction, a first ejection section 56 is provided. The second conveyance section 52 forms a conveyance route from the branch portion 58 to the first ejection section 56. The sheet S conveyed from the first conveyance section 51 to the second conveyance section 52 through the branch portion 58 is ejected to the outside of the sheet conveyance device 400 from the first ejection section 56. According to the second conveyance section 52, the sheet S can be conveyed without passing through an image forming section 240 of the image forming apparatus 200.

The conveyance distance of the sheet S in the second conveyance section 52 is preferably configured to be equal to or longer than the length of the long side of the sheet S that can be stored in the sheet feed device 100 and conveyed by the sheet conveyance device 400. For example, the second conveyance section 52 is preferably configured to have a length equal to or longer than the long side of sheets of a standard maximum size except for long sheets such as roll sheets. Note that the conveyance distance of the sheet S in the first conveyance section 51 is not particularly limited as long as the required number of second detectors 72 can be arranged and the sheet S can be stably conveyed.

An outlet port 57 is provided on the downstream side of the third conveyance section 53 in the sheet conveyance direction. The third conveyance section 53 constitutes a conveyance route from the branch portion 58 to the outlet port 57. The sheet S conveyed from the first conveyance section 51 to the third conveyance section 53 through the branch portion 58 is conveyed from the sheet conveyance device 400 to the image forming apparatus 200 through the outlet port 57. According to the third conveyance section 53, the sheet S can be conveyed via the image forming section 240 of the image forming apparatus 200. Note that in the first image forming system 10A, when the sheet conveyance device 400 is used alone, the outlet port 57 is used as an ejection section for the sheet S conveyed by the third conveyance section 53.

The conveyance distance of the sheet S in the third conveyance section 53 is preferably shorter than the length of the second conveyance section 52. The third conveyance section 53 is preferably configured to have such a length that the conveyance distance of the sheet S from the branch portion 58 to the outlet port 57 is shortest.

The first detector 71 is disposed in the second conveyance section 52, and detects a sheet characteristic of the sheet S conveyed to the second conveyance section 52 in the period including the state where the first image forming system 10A is not executing a print job. For example, when the first image forming system 10A is not executing a print job, such as in a printing standby state or a sleep state, the first detector 71 can detect the sheet characteristic of the sheet S by causing the second conveyance section 52 to convey the sheet S. It is preferable that the first detector 71 detects the sheet characteristic in a state where the conveyance of the sheet S is stopped or in a state where the conveyance of the sheet S is performed at a lower speed than a normal conveyance speed for image formation. By detecting the sheet characteristic while the sheet S is in the stopped state and in the low-speed conveyance state, detection accuracy of the sheet characteristic can be enhanced.

The second detector 72 is disposed in the first conveyance section 51 and detects a sheet characteristic of the sheet S conveyed to the first conveyance section 51. The second detector 72 preferably detects the sheet characteristic while the sheet S is being conveyed at a normal conveyance speed for image formation in a print job. By detecting the sheet characteristic at the normal conveyance speed, the sheet characteristic can be detected without degrading the productivity of the print job.

The first detector 71 and the second detector 72 are capable of detecting the type and size of the sheet S, the physical property of the sheet S, and the like. Examples of the type of the sheet S include plain paper, high-quality paper, and glossy paper. Examples of the physical property of the sheet S includes thickness, basis weight, surface conditions such as smoothness, stiffness, charge amount, moisture amount, curl amount, and a flow mark indicating the angle of the fiber direction of the sheet.

The first detector 71 and the second detector 72 include various sensors for detecting sheet characteristics. For example, the first detector 71 and the second detector 72 each include an imaging sensor for detecting the type of the sheet S. The imaging sensor includes a light source that irradiates the front surface of the sheet S with light, a light source that irradiates the back surface of the sheet S with light, and an imaging element that images the surface of the sheet S. The imaging sensor acquires an image in the reflection state during the front irradiation of the sheet S and an image in the transmission state during the back irradiation of the sheet S.

The first detector 71 includes an optical sensor and a weight sensor for detecting the size, weight, and basis weight of the sheet S. The optical sensor includes a light receiving element that detects an end of the sheet S on the inspection table through which the sheet S being conveyed passes. The weight sensor detects the weight per unit area of the sheet S from a change in the weight of the inspection table when the sheet S passes. The weight sensor detects the size and the area of the sheet S from the output of the optical sensor, and acquires the basis weight from the weight of the unit area of the sheet S detected by the weight sensor.

The first detector 71 includes, for example, a sensor that detects an electrical characteristic of the sheet S as the sheet characteristic. The first detector 71 electrifies the sheet S with a sensor, thereby detecting, as the sheet characteristic of the sheet S, an electrical resistance value, a charge amount, a moisture content, and the like of the sheet S. The first detector 71 includes, for example, a sensor that detects the sheet characteristic in a test in which the sensor directly contacts the sheet S. The first detector 71 detects the stiffness of the sheet S as the sheet characteristic with the sensor in direct contact with the sheet S.

The second detector 72 preferably includes a sensor that detects the sheet characteristic without contacting the sheet S. The second detector 72 detects the sheet characteristic without deforming the sheet characteristic by an external force. Accordingly, it is possible to suppress the occurrence of a conveyance failure, a paper jam, or the like during the conveyance of the sheet S in the image forming apparatus 200, particularly, during the conveyance of the sheet S in the image forming section 240 and the fixing section 248. Furthermore, the second detector 72 preferably includes a sensor that detects the sheet characteristic without charging the sheet S. The second detector 72 detects the sheet characteristic without charging the sheet S. Thus, it is possible to suppress conveyance failure due to sticking of the sheet S during conveyance, and can accurately perform charge movement important in the electrophotographic process in the image forming section 240, for example, transfer of a toner image from the intermediate transfer belt 246 to the sheet S. Since the second detector 72 detects the sheet characteristic in the non-contact and non-charging manner, in the first image forming system 10A, it is possible to reduce the conveyance failure of the sheet S and improve the transfer accuracy in the image formation. Thus, a decrease in the reliability of image formation can be suppressed.

### (Image Forming Apparatus 200)

The image forming apparatus 200 forms a predetermined image on the surface of the sheet S conveyed from the sheet conveyance device 400. The image forming apparatus 200 includes an operation and display part 220, a scanner 230, an image forming section 240, a conveyance section 250, a temperature detector 241, a humidity detector 242, and the like.

The operation and display part 220 includes an operation part and a display part. The display part includes, for example, a display device such as a liquid crystal display, and displays an image such as a GUI, various operation screens, and the like. The GUI is an abbreviation for Graphical User Interface. The operation part includes a touch screen formed so as to cover the display screen of the display part, and various operation buttons such as numeric buttons and a start button. The operation part accepts a predetermined operation instruction from the user.

The scanner 230 optically scans a document conveyed from the ADF onto a contact glass or a document placed on the contact glass. The scanner 230 reads a document image by forming, on a light receiving surface of a CCD sensor, an image of reflected light of light emitted from a light source to illuminate and scan a document. The scanner 230 performs A/D conversion on the read image to generate image data. The ADF is an automatic document feeder, and is an abbreviation for Auto Document Feeder. The CCD is an abbreviation for Charge Coupled Device.

The image forming section 240 forms an image on a sheet S on the basis of the image data generated by the scanner 230. The image forming section 240 includes photosensitive drums 241Y, 241M, 241C, and 241K and charging sections 242Y, 242M, 242C, and 242K corresponding to the respective colors of yellow, magenta, cyan, and black. The image forming section 240 includes exposure sections 243Y, 243M, 243C, and 243K, developing sections 244Y, 244M, 244C, and 244K, and primary transfer rollers 245Y, 245M, 245C, and 245K. The image forming section 240 further includes an intermediate transfer belt 246, a secondary transfer roller 247, and a fixing section 248.

The charging sections 242Y, 242M, 242C, and 242K uniformly charge photosensitive drums 241Y, 241M, 241C, and 241K. The exposure sections 243Y, 243M, 243C, and 243K are each composed of a laser light source, a polygon mirror, a lens, and the like. The exposure sections 243Y, 243M, 243C, and 243K scan and expose the surfaces of the photosensitive drums 241Y, 241M, 241C, and 241K on the basis of image data with laser beams to form electrostatic latent images. The developing sections 244Y, 244M, 244C, and 244K cause toner of the respective colors to adhere to the electrostatic latent images on the photosensitive drums 241Y, 241M, 241C, and 241K to develop the images.

The primary transfer rollers 245Y, 245M, 245C, and 245K sequentially transfer the toner images in the respective colors formed on the photosensitive drums 241Y, 241M, 241C, and 241K onto the intermediate transfer belt 246. That is, a color toner image in which four color toner images are superimposed is formed on the intermediate transfer belt 246 by primary transfer. The secondary transfer roller 247 collectively transfers the toner image on the intermediate transfer belt 246 onto one side of a sheet S supplied from a sheet supply tray. This transfer is called secondary transfer. The fixing section 248 fixes the toner image on the sheet S by heating and pressing by passing the sheet S through a nip portion formed by the fixing roller and the pressure roller.

The conveyance section 250 includes a plurality of conveyance rollers 251 and the like provided along a predetermined conveyance route for conveying the sheet S. The conveyance section 250 drives the conveyance rollers 251 to convey the sheet S along a predetermined conveyance route in the image forming apparatus 200, thereby carrying out the sheet S after image formation to the post-processing device 300.

The temperature detector 241 is installed in the image forming apparatus 200 and detects a temperature in the image forming apparatus 200 in the period including the state in which the first image forming system 10A is not executing a print job. The temperature detector 241 is composed of, for example, a thermocouple, a thermistor, a thermopile or the like.

The humidity detector 242 is installed in the image forming apparatus 200, and detects the humidity in the image forming apparatus 200 in the period including the state where the image forming system 10A is not executing a print job. The humidity detector 242 is composed of, for example, a resistance sensor or a capacity sensor.

### (Post-Processing Device 300)

The post-processing device 300 performs predetermined post-processing specified by a print job on a sheet S on which an image has been formed in the image forming apparatus 200. The post-processing device 300 includes a post-processing unit. The post-processing unit performs, for example, at least one of perforation processing, folding processing, foil stamping processing, binding, cutting processing, stapling, gluing, binding, and the like. The post-processing unit performs predetermined post-processing on the sheet S that is conveyed by the conveyance section 350 in the post-processing device 300 and on which an image has been formed. The sheet S on which the predetermined post-processing has been performed by the post-processing unit is ejected from the second ejection section 351 and stacked on a sheet ejection tray 352.

### Block Diagram of First Image Forming System 10A

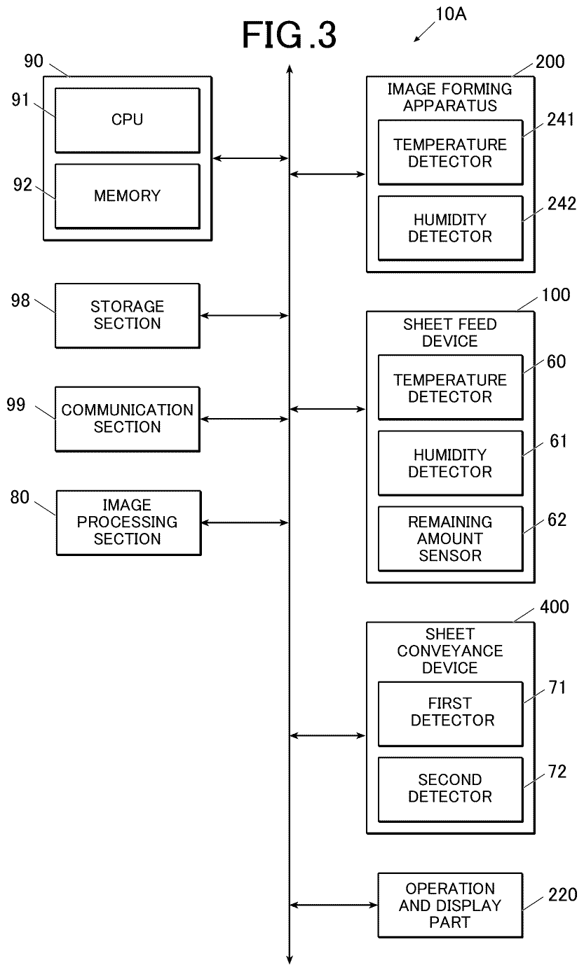

FIG. 3 is a block diagram of the image forming system 10A according to the present embodiment. The first image forming system 10A includes a controller 90, a storage section 98, a communication section 99, an image processing section 80, and an operation and display part 220. The image forming apparatus 200 of the first image forming system 10A includes a temperature detector 241 and a humidity detector 242. The sheet feed device 100 of the first image forming system 10A includes a temperature detector 60, a humidity detector 61, and a remaining amount sensor 62. The sheet conveyance device 400 of the first image forming system 10A includes a first detector 71 and a second detector 72. Note that hereinafter, the description of the components that are the same as those of the first image forming system 10A illustrated in FIG. 2 and described above will be omitted.

The controller 90 includes, for example, a CPU 91 and a memory 92. The CPU is an abbreviation for Central Processing Unit. The CPU 91 reads various process programs stored in the memory 92, and controls the operation of each component of the first image forming system 10A according to the read programs. The memory 92 is composed of a ROM, a RAM and the like. The ROM is an abbreviation for Read Only Memory. The RAM is an abbreviation for Random Access Memory. The memory 92 stores various process programs for controlling each component of the image forming system 10, parameters necessary for executing the programs, and the like. The memory 92 forms a work area in which the various process programs, parameters, and the like are temporarily stored read in various processes that are executed and controlled by the CPU 91.

The storage section 98 is configured by, for example, a nonvolatile memory such as an HDD, an SSD, and/or a flash memory. The HDD is an abbreviation for Hard Disk Drive. The SSD is an abbreviation for Solid State Drive. The storage section 98 stores various process programs that are executed by the CPU 91 and information on process functions of its own apparatus necessary for executing the programs. The storage section 98 stores image data read by the scanner 230, image data transmitted from the client terminal 30 or the like, and sheet characteristic information of the sheet S detected by the first detector 71 and the second detector 72. Furthermore, the storage section 98 stores environment information including the temperature detected by the temperature detector 60 or the like and the humidity detected by the humidity detector 61 or the like, remaining sheet amount information on the remaining amount of sheets S detected by the remaining amount sensor 62, and the like.

The communication section 99 is constituted by an NIC, a modem, or the like. The NIC is an abbreviation for Network Interface Card. The communication section 99 connects the first image forming system 10A to the first network N1 or the like, and performs transmission and reception of various types of data with external apparatuses, such as the printer controller 20 and the management apparatus 40, for example.

The image processing section 80 includes a circuit that performs analog-to-digital conversion and a circuit that performs digital image processing. The image processing section 80 generates digital image data by performing A/D conversion on the analog image signal from the scanner 230. The image processing section 80 analyzes a print job acquired from, for example, the client terminal 30 or the like and rasterizes each page of a document to generate digital image data. The image processing section 80 performs image processing, such as color conversion, correction according to the initial setting or user setting, and compression, on the image data as necessary, and outputs the image data after the image processing to the image forming section 240.

The operation and display part 220 displays various types of operation screens in accordance with display control signals input from the controller 90. The operation and display part 220 receives various types of input operations by the user and output operation signals to the controller 90. The operation and display part 220 can also display, on the screen, an environment information image visualizing changes in temperature and humidity in the first image forming system 10A in time series, based on image data on the environment information image transmitted from the management apparatus 40.

The temperature detector 241 of the image forming apparatus 200 detects the temperature in the image forming apparatus 200 and outputs environment information including the detected temperature to, for example, the storage section 98. The humidity detector 242 detects the humidity in the image forming apparatus 200, and outputs environment information including the detected humidity to, for example, the storage section 98.

The temperature detector 60 of the sheet feed device 100 detects the temperature in the sheet feed device 100, and outputs environment information including the detected temperature to, for example, the storage section 98. The humidity detector 61 detects the humidity in the sheet feed device 100, and outputs environment information including the detected humidity to, for example, the storage section 98. The remaining amount sensor 62 detects the remaining amount (number) of sheets stored in each sheet feed tray, and outputs remaining sheet amount information including the detected remaining amount of sheets to, for example, the storage section 98.

The first detector 71 of the sheet conveyance device 400 detects the sheet characteristic of the sheet S passing through the second conveyance section 52, and outputs sheet characteristic information including the detected sheet characteristic to, for example, the storage section 98. The second detector 72 detects the sheet characteristic of the sheet S passing through the first conveyance section 51, and outputs sheet characteristic information including the detected sheet characteristic to, for example, the storage section 98. The controller 90 controls the communication section 99 to transmit the environment information, the remaining sheet amount information and the sheet characteristic information stored in the storage section 98 to the management apparatus 40 via the first network N1 and the second network N2 at a predetermined timing.

Even in the state where the first image forming system 10A is not executing a print job, a predetermined amount of power is supplied to the temperature detector 241, the humidity detector 242, the temperature detector 60, the humidity detector 61, the remaining amount sensor 62, the first detector 71, and the second detector 72. Therefore, during non-execution of a print job, each detector such as the temperature detector 241 can perform detection of temperature, humidity, or the like according to the purpose.

### Configuration Example of Printer Controller 20

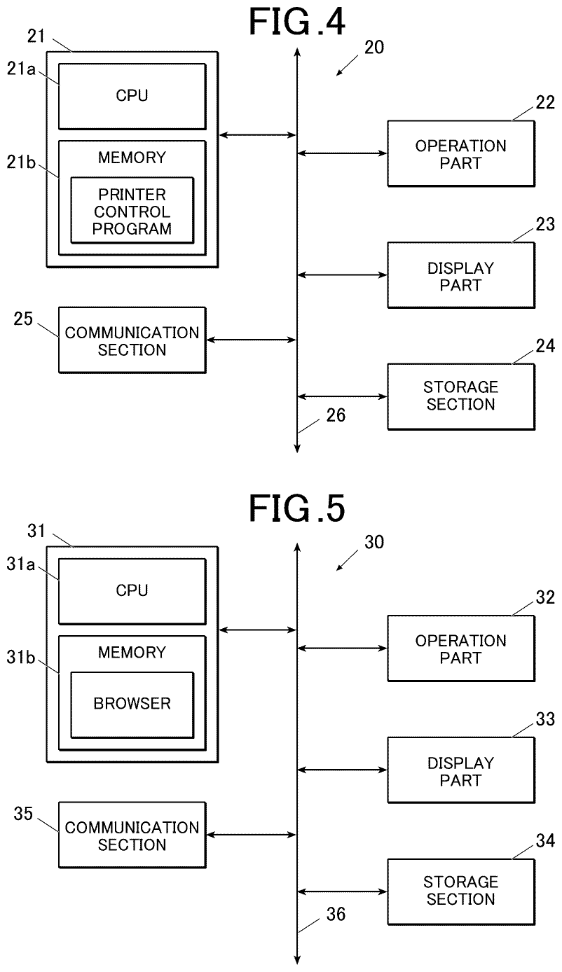

FIG. 4 is a block diagram of the printer controller 20 according to the present embodiment. The printer controller 20 includes a controller 21, an operation part 22, a display part 23, a storage section 24, and a communication section 25. The controller 21, the operation part 22, the display part 23, the storage section 24, and the communication section 25 are connected to each other by wiring 26 such as a bus.

The controller 21 includes a CPU 21a, a memory 21b, and the like. The controller CPU 21a reads a printer control program stored in the memory 21b or the like, and controls the operation of each component of the printer controller 20 according to the read program. According to various programs, the CPU 21a generates a print image based on a print job received from an external apparatus such as the client terminal 30. The memory 21b includes a ROM, a RAM, and the like. The memory 21b stores, for example, the printer control program for controlling each component of the printer controller 20.

The operation part 22 includes, for example, at least one of a mouse, a keyboard, a switch, a button, a sensor, and the like. The operation part 22 may be, for example, a touch screen integrally combined with a display. The operation part 22 receives an instruction corresponding to a user's input operation, and outputs an operation signal based on the received instruction to the controller 21.

The display part 23 is, for example, a display device such as a liquid crystal display or an organic EL display. The display part 23 displays, for example, a GUI for receiving various input operations from the user, various operation screens, and the like. Note that at least one of the operation part 22 and the display part 23 described above can be omitted from the configuration of the printer controller 20.

The storage section 24 includes a large-capacity storage device such as an SSD or an HDD. In the storage section 24, for example, various programs including an operating system, a control program, and the like are stored.

The communication section 25 is constituted by an NIC or a modem, for example. The communication section 25 communicates various types of data such as a print job with the client terminal 30 via the first network N1 or the like.

### Configuration Example of Client Terminal 30

FIG. 5 is a block diagram of the client terminal 30 according to the present embodiment. The client terminal 30 includes a controller 31, an operation part 32, a display part 33, a storage section 34, and a communication section 35. The controller 31, the operation part 32, the display part 33, the storage section 34, and the communication section 35 are connected to each other by wiring 36 such as a bus.

The controller 31 includes a CPU 31a, a memory 31b, and the like. The controller CPU 31a reads various process programs stored in the memory 31b or the like, and controls the operation of each component of the client terminal 30 according to the read programs. The controller 31 generates a print job including a print instruction of a predetermined image in accordance with a program of various programs. The print job includes, for example, print data and print setting data in a PDL format. The PDL is an abbreviation for Page Description Language. The print setting data includes information on the number of pages, the number of copies, the type, size, and basis weight of a sheet, settings of an inspection function, settings of single-sided printing/double-sided printing, and the like. The memory 31b includes a ROM, a RAM, and the like. The memory 31b stores a browser, a process program, and the like for displaying a chart or the like visualizing changes in temperature and humidity in the image forming system 10 in time series.

The operation part 32 includes, for example, at least one of a mouse, a keyboard, a switch, a button, a sensor, and the like. The operation part 32 may be, for example, a touch screen integrally combined with a display. The operation part 32 receives an instruction corresponding to an input operation by the user and outputs an operation signal based on the received instruction to the controller 31.

The display part 33 is, for example, a display device such as a liquid crystal display or an organic EL display. The display part 33 displays a GUI for receiving various input operations from the user, various operation screens, and the like. The display part 33 displays, on the screen, an environment information image visualizing changes in temperature and humidity in the first image forming system 10A, for example, based on the image data related to the environment information image transmitted from the management apparatus 40.

The storage section 34 includes, for example, a large-capacity storage device such as an SSD and an HDD. In the storage section 34, for example, various programs including an operating system, a control program, and the like are stored.

The communication section 35 is constituted by an NIC or a modem, for example. The communication section 35 communicates a print job with the printer controller 20 via the first network N1 and the second network N2, and communicates image data on the environment information image and the like with the management apparatus 40 and the like.

### Configuration Example of Management Apparatus 40

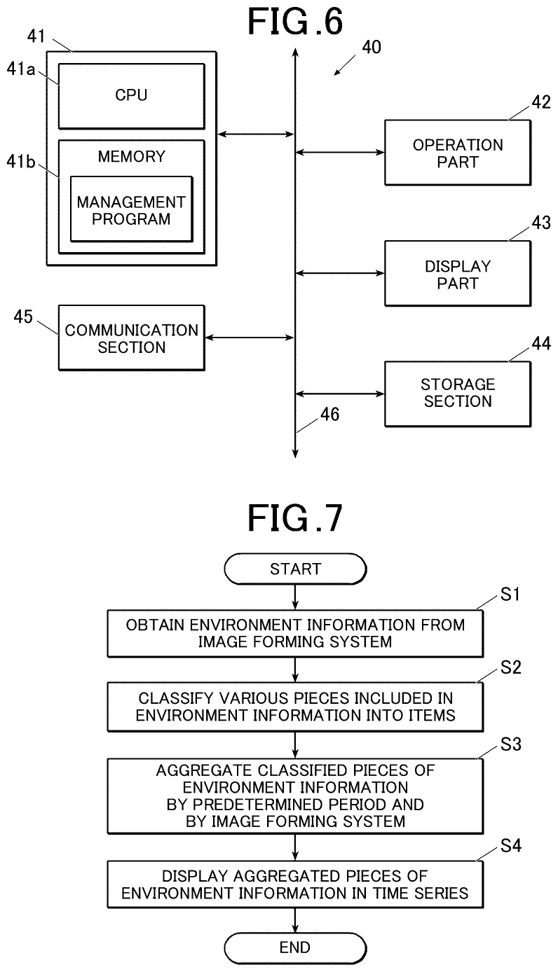

FIG. 6 is a block diagram of the management apparatus 40 according to the present embodiment. The management apparatus 40 includes a controller 41 (hardware processor), an operation part 42, a display part 43, a storage section 44, and a communication section 45. The controller 41, the operation part 42, the display part 43, the storage section 44, and the communication section 45 are connected to each other by wiring 46 such as a bus.

The controller 41 includes a CPU 41a, a memory 41b, and the like. The controller CPU 41a reads a management program stored in the memory 41b or the like, and controls the operation of each component of the management apparatus 40 according to the read program. For example, the CPU 41a acquires, for example, environment information on the first image forming system 10A or the like in the period including the state where the first image forming system 10A or the like is not executing a print job. Based on the acquired environment information or the like, the CPU 41a performs control to present, to the client terminal 30 or the like, an environment information image visualizing changes in temperature, humidity, and the like in the first image forming system 10A. The memory 41b includes a ROM, a RAM, and the like. The memory 41b stores the management program for controlling each component of the management apparatus 40, parameters necessary for execution of the program, and the like.

The operation part 42 includes, for example, at least one of a mouse, a keyboard, a switch, a button, a sensor, and the like. The operation part 42 may be, for example, a touch screen integrally combined with a display. The operation part 42 receives an instruction corresponding to a user's input operation, and outputs an operation signal based on the received instruction to the controller 41.

The display part 43 is, for example, a display device such as a liquid crystal display or an organic EL display. The display part 43 can display, on the screen, a GUI or the like for receiving various input operations from the user.

The storage section 44 includes a large-capacity storage device such as an SSD or an HDD. In the storage section 44, for example, various programs including an operating system, a control program, and the like are stored.

The communication section 45 is constituted by an NIC or a modem, for example. The communication section 45 communicates the environment information and the like with the first image forming system 10A and the like via the first network N1 and the second network N2, and communicates image data and the like on an environment information image with external apparatuses such as the client terminal 30.

### Operation Example of Management Apparatus 40

FIG. 7 is a flowchart illustrating an example of the operation of the management apparatus 40 that manages the environment information on the image forming system 10 according to the present embodiment. The controller 41 of the management apparatus 40 executes the management program stored in the memory 41b or the like to realize control to visualize changes in the environment information including the temperature and the humidity in the image forming system 10 in time series.

The controller 41 acquires environment information from the image forming system 10 via the first network N1 and the second network N2 (Step S1). The environment information also includes environment information in the period including the state in which the image forming system 10 is not executing a print job, such as a sleep state. In a case where the management apparatus 40 manages a plurality of image forming systems 10, the controller 41 acquires the management information (environment information) from each of the plurality of image forming systems 10. The image forming system 10 may collectively transmit the stored environment information to the management apparatus 40, for example, at the timing when the power is turned off. Furthermore, the image forming system 10 may transmit the environment information to the management apparatus 40 every preset certain period, or may transmit the acquired environment information to the management apparatus 40 in real time.

The controller 41 classifies various pieces included in the acquired environment information into items (Step S2). The various pieces included in the environment information include, for example, environment information including the temperature and the humidity of the (each) image forming system 10, power supply state information on the image forming system 10, environment information detection time information, identification information on the image forming system 10, and the like.

The controller 41 aggregates the classified pieces of the environment information by predetermined period, image forming system, and the like (Step S3). For example, the controller 41 can aggregate pieces of the environment information to be used in accordance with the type of the display pattern of an environment information image that is presented to the user, such as an operator. To be specific, the controller 41 may aggregate changes in pieces of environment information on the temperature and the humidity in a predetermined power state for a predetermined period with respect to the first image forming system 10A, and generate an environment information image based on the aggregated pieces of environment information. The controller 41 may, for example, calculate the average temperature and the average humidity in a predetermined period about the first image forming system 10A and generate an environment information image based on the calculation results.

The controller 41 presents an environment information image visualizing the aggregated pieces of the environment information in time series to an external apparatus such as the client terminal 30 (Step S4). In the present embodiment, multiple display patterns are prepared as the environment information image. To be specific, as described later, in one example, seven patterns of a first environment information image 33a to a seventh environment information image 33g are prepared. The user can select an environment information image with the operation part or the like of the client terminal 30 in accordance with, for example, the use environment, the use state, or the like. Furthermore, an environment screen image (environment information image) may be set by default.

In the above, the case of managing the environment information on the image forming system 10 has been described as an example, but the operation illustrated in FIG. 7 is applicable to the case of managing the remaining sheet amount information and the sheet characteristic information on the image forming system 10. To be specific, when acquiring, from the first image forming system 10A, the remaining sheet amount information in the period including the state where a print job is not being executed, the controller 41 classifies various pieces included in the remaining sheet amount information. Subsequently, the controller 41 aggregates the classified various pieces by predetermined period, image forming system, and the like. For example, the controller 41 aggregates the remaining sheet amount information on each sheet feed tray during a predetermined period or the like with respect to the first image forming system 10A, and generates an environment information image in which the aggregated remaining sheet amount information is associated with the above-described environment information. Subsequently, the controller 41 presents the generated environment information image to an external apparatus such as the client terminal 30.

Furthermore, when acquiring, from the first image forming system 10A, the sheet characteristic information in the period including the state in which a print job is not being executed, the controller 41 classifies various pieces included in the sheet characteristic information. Subsequently, the controller 41 aggregates the classified various pieces by predetermined period, image forming system, and the like. For example, the controller 41 calculates and aggregates the sheet characteristic information in a predetermined period with respect to the first image forming system 10A, and generates an environment information image in which the aggregated sheet characteristic information is associated with the above-described environment information. Subsequently, the controller 41 presents the generated environment information image to an external apparatus such as the client terminal 30.

Furthermore, when acquiring, from the first image forming system 10A, the sheet characteristic information on each of the plurality of sheet feed trays in the period including the state in which a print job is not being executed, the controller 41 classifies various pieces included in the sheet characteristic information. Subsequently, the controller 41 aggregates the classified various pieces by predetermined period, image forming system, and the like. For example, the controller 41 calculates and aggregates the sheet characteristic information on each of the plurality of sheet feed trays in a predetermined period with respect to the first image forming system 10A, and generates an environment information image in which the aggregated sheet characteristic information on each of the plurality of sheet feed trays is associated with the above-described environment information. Subsequently, the controller 41 presents the generated environment information image to an external apparatus such as the client terminal 30.

### Display Example of First Environment Information Image 33a

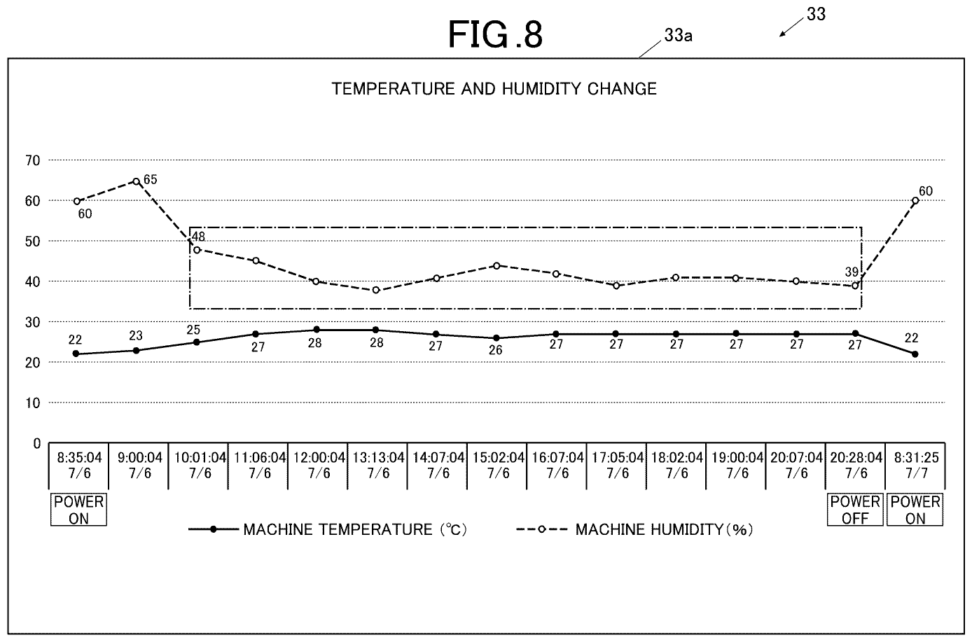

FIG. 8 is a diagram illustrating an example of a first environment information image 33a displayed on the display part 33 of the client terminal 30 according to the present embodiment. The management apparatus 40 causes the display part 33 of the client terminal 30 to display, for example, the first environment information image 33a based on the environment information acquired from the first image forming system 10A. In the first environment information image 33a, a line chart is displayed that visualizes, in a time-series manner, changes in temperature and humidity at the time of power-on of the image forming system 10A and at the time of elapse of a predetermined time from the power-on of the image forming system 10A. The horizontal axis corresponding to a first axis of the chart represents time, and the vertical axis corresponding to a second axis thereof represents temperature and humidity. The horizontal axis of the chart includes a period of July 6 and July 7, and the period is divided in units of about one hour. The power-on period in the chart also includes a change in the temperature and humidity of the first image forming system 10A in the period including the state in which the first image forming system 10A is not executing a print job, such as the sleep state. In the chart, the power-off time of the first image forming system 10A means the time of the temperature and humidity recorded immediately before (e.g., a few seconds before or a few tens of seconds before) the time at which the power is turned off.

By referring to the first environment information image 33a, the user can confirm that the humidity is high at the time when the power of the first image forming system 10A is turned on, and that the humidity decreases and becomes stable when a predetermined time elapses from when the power of the first image forming system 10A is turned on. Further, by referring to the first environment information image 33a, the user can confirm that the humidity increases after the power of the first image forming system 10A is turned off. Thus, according to the first environment information image 33a, the environment information in the period in which a print job is not being executed, including the state in which the power is off, can also be visualized, so that the user can grasp the time period in which production can be performed in the state in which the temperature and humidity are most stable. Therefore, in a busy season, in order to secure a long time period in which the temperature and humidity are stable, it is possible to determine making a change in the operation or the production workflow, such as advancing the time period in which the power is turned on.

### Display Example of Second Environment Information Image 33b

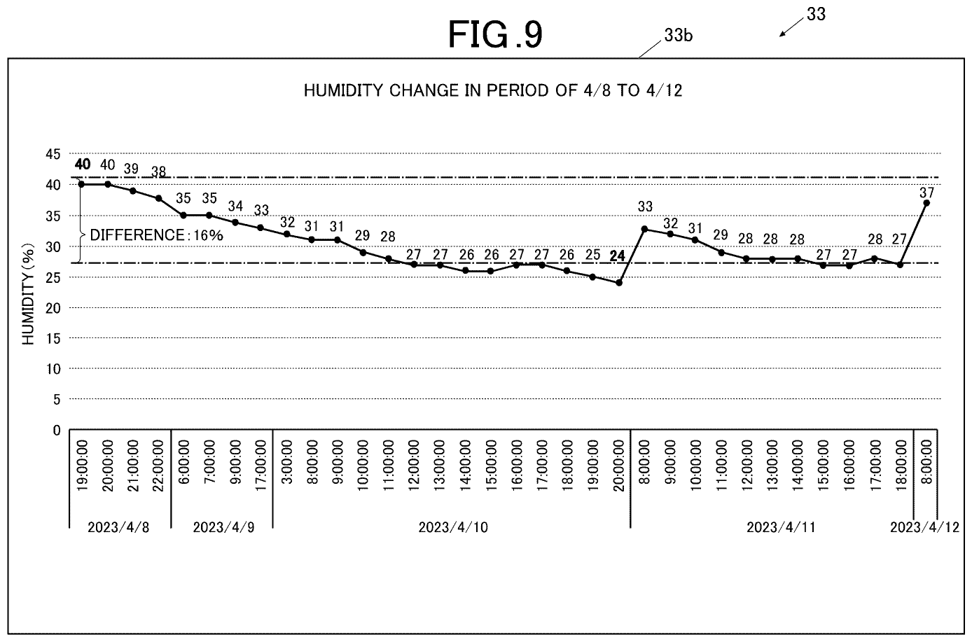

FIG. 9 is a diagram illustrating an example of a second environment information image 33b displayed on the display part 33 of the client terminal 30 according to the present embodiment. The management apparatus 40 causes the display part 33 of the client terminal 30 to display, for example, the second environment information image 33b based on the environment information acquired from the first image forming system 10A. In the second environment information image 33b, a line chart is displayed that visualizes, in a time-series manner, changes in humidity from when the power of the image forming system 10A is turned on to when the power thereof is turned off in the period of April 8 to Apr. 12, 2023. The horizontal axis of the chart represents time, and the vertical axis represents temperature and humidity. The horizontal axis of the chart includes the period of April 8 to Apr. 12, 2023, and the main period(s) is divided in units of one hour. The power-on period in the chart also includes a change in the temperature and humidity of the first image forming system 10A in the period including the state in which the first image forming system 10A is not executing a print job, such as the sleep state.

By referring to the second environment information image 33b, the user can confirm that there is a 16% difference in humidity between April 8 and April 10, which are five days from April 8 in spring, and that the humidity changes from day to day. For example, in a case where the humidity difference/drop is large, performances of the components such as charging electrodes of the first image forming system 10A are influenced, and a possibility that an image error or the like occurs increases. Thus, according to the second environment information image 33b, changes in humidity during a certain period in a predetermined season can be visualized, so that it is possible to grasp the date on which production can be performed with the humidity in the most stable state. Therefore, in a busy season, in order to secure a long time period in which the temperature and humidity are stable, it is possible to determine making a change in the operation or the production workflow, such as advancing the time period in which the power is turned on.

### Display Example of Third Environment Information Image 33c

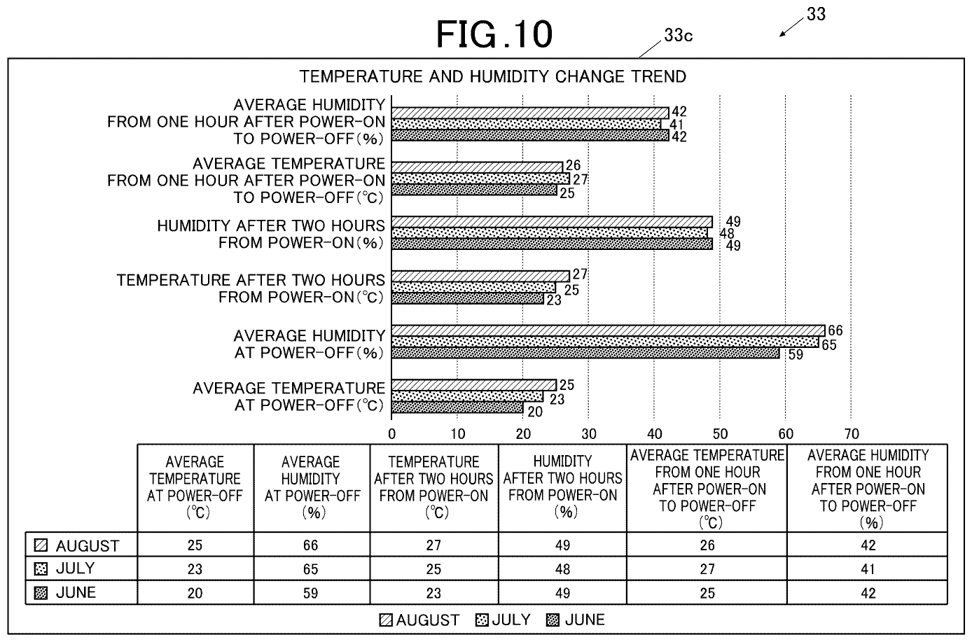

FIG. 10 is a diagram illustrating an example of a third environment information image 33c displayed on the display part 33 of the client terminal 30 according to the present embodiment. The management apparatus 40 causes the display part 33 of the client terminal 30 to display, for example, the third environment information image 33c based on the environment information acquired from the first image forming system 10A. In the third environment information image 33c, a bar chart and a table are displayed that indicate the average temperature and the average humidity in each detection period from June to August in summer. The horizontal axis of the chart represents the average temperature/humidity, and the vertical axis thereof represents each detection period. Each detection period includes, for example, the period from the elapse of one hour from the power-on to the power-off, the time of elapse of two hours from the power-on, and the power-off time. The average temperature and the average humidity in the chart also include the temperature and the humidity of the first image forming system 10A in the period including the state where a print job is not being executed, such as when the first image forming system 10A is in the sleep state.

By referring to the third environment information image 33c, the user can confirm that during June to August, the average humidity in the apparatus is higher and the changes in temperature and humidity are greater when the first image forming system 10A is turned off than when it is turned on. This is because the average humidities indoor and outdoor increase in summer from June to August, but an internal dehumidification unit does not operate at the time of the power-off of the first image forming system 10A. Further, by referring to the third environment information image 33c, the user can confirm that the humidity is high and the humidity does not fall within the recommended environment for high productivity and stable production until two hours elapse from the power-on of the first image forming system 10A. Thus, according to the third environment information image 33c, long-term changes in temperature and humidity can be visualized on a monthly basis and a seasonal basis. Therefore, the user can improve the production workflow by, for example, turning on the power of the first image forming system 10A earlier than usual in a busy month, thereby realizing long-term production in the recommended environment for high productivity. Note that in the third environment information image 33c, the temperature and humidity data is displayed on a monthly basis, but the temperature and humidity data may be displayed, for example, on a quarterly basis.

### Display Example of Fourth Environment Information Image 33d

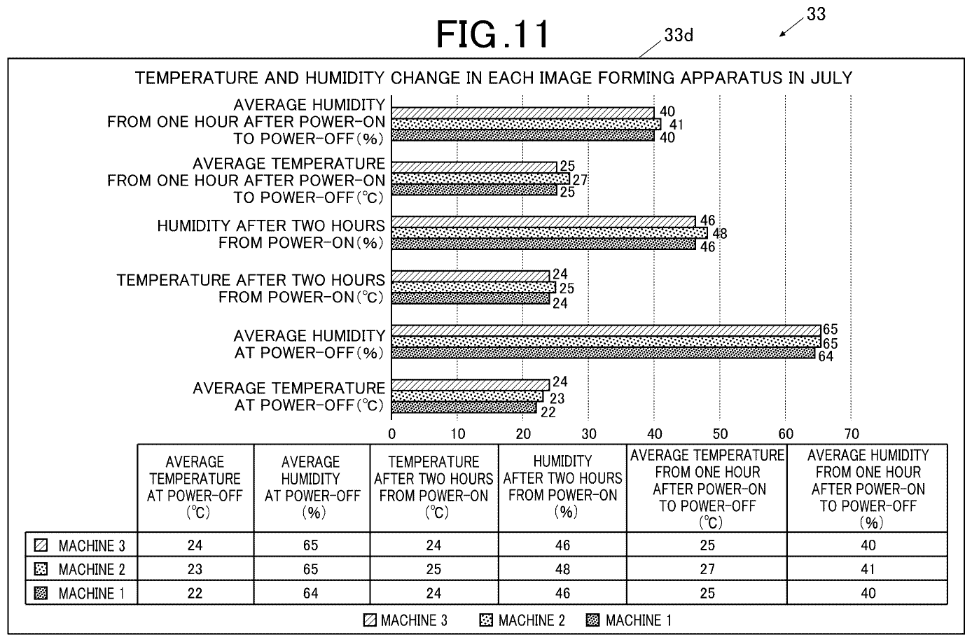

FIG. 11 is a diagram illustrating an example of a fourth environment information image 33d displayed on the display part 33 of the client terminal 30 according to the present embodiment. The management apparatus 40 acquires environment information from, for example, each of three image forming systems 10 that are the first image forming systems 10A, the second image forming system 10B, and another image forming system (not illustrated). The management apparatus 40 causes the display part 33 of the client terminal 30 to display the fourth environment information image 33d based on the acquired environment information. In the fourth environment information image 33d, a bar chart and a table are displayed that indicate the average temperature and the average humidity in each measurement (detection) period of July in each of the three image forming systems 10. The horizontal axis of the chart represents the average temperature and the average humidity, and the vertical axis represents each detection period. Each detection period includes, for example, the period from the elapse of one hour from the power-on to the power-off, the time of elapse of two hours from the power-on, and the power-off time. The average temperature and the average humidity in the bar chart and the table also include the temperature and the humidity of each image forming system 10 in the period including the state in which a print job is not being executed, for example, when the image forming system 10 is in the sleep state. Note that the three image forming systems 10 are installed at different locations in the same room.

By referring to the fourth environment information image 33d, the user can confirm that, for example, the average temperature of the second image forming system 10B is high in the period from the elapse of one hour from the power-on to the power-off. This is because how the wind of an air conditioner hits the three image forming systems 10, the positions of a window(s) and a door and the like in the room affect the temperature and the humidity of the image forming systems 10 that are placed at different locations in the room. That is, it means that even in the same room, the temperature and the humidity vary depending on the location. Thus, according to the fourth environment information image 33d, changes in the average temperatures and the average humidities in the three image forming systems 10 can be displayed side by side and compared. Therefore, the user can determine whether the layout of the production environment, including the locations of the three image forming systems 10, the settings of the air conditioner, the number of humidifiers and dehumidifiers, and the like, is appropriate.

### Display Example of Fifth Environment Information Image 33e

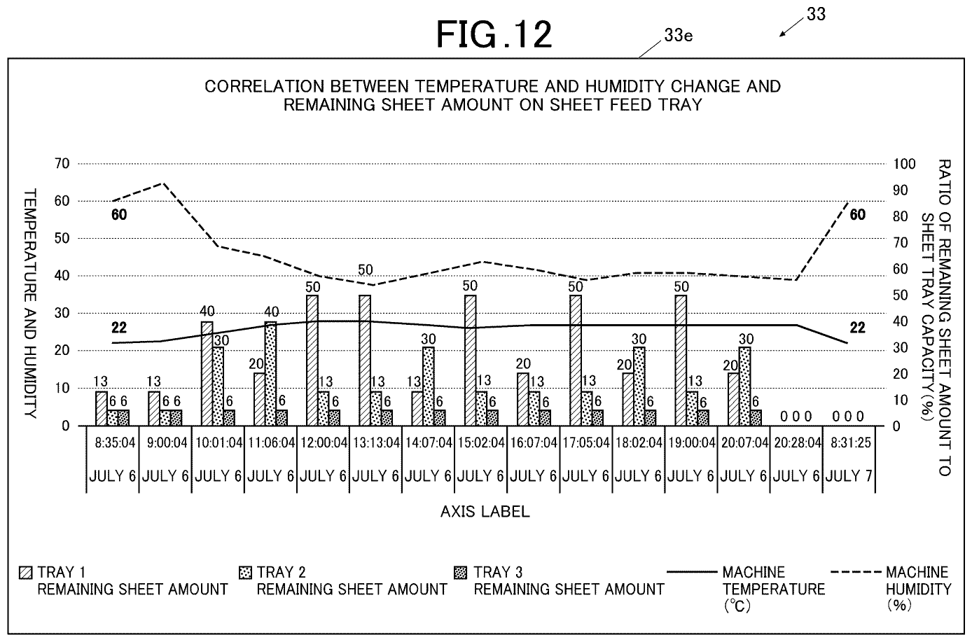

FIG. 12 is a diagram illustrating an example of a fifth environment information image 33e displayed on the display part 33 of the client terminal 30 according to the present embodiment. The management apparatus 40 causes the display part 33 of the client terminal 30 to display, for example, the fifth environment information image 33e based on the environment information, the remaining sheet amount information and the like acquired from the first image forming system 10A. In the fifth environment information image 33e, a line chart and a bar chart are displayed that indicate correlation between the remaining sheet amount on each of the plurality of sheet feed trays and changes in temperature and humidity. The horizontal axis of the charts represents time. The horizontal axis of the charts mainly includes a period of July 6, and the period is divided in units of about one hour. The left side of the vertical axis of the charts represents the temperature and humidity, and the right side of the vertical axis thereof represents the remaining sheet amount with respect to the capacity of each sheet feed tray. Furthermore, the temperature and the humidity in the chart also include the temperature and the humidity of the image forming system 10A in the period including the state where the image forming system 10A is not executing a print job, for example, in the sleep state.

By referring to the fifth environment information image 33e, the user can confirm that the humidity is high at the time of power-on of the first image forming system 10A, and that the humidity decreases and is stable after a predetermined time elapses from the power-on of the first image forming system 10A. Furthermore, by referring to the fifth environment information image 33e, the user can confirm that the humidity increases after the power-off of the first image forming system 10A. Furthermore, by referring to the fifth environment information image 33e, the user can confirm that, for example, the remaining sheet amount on each sheet feed tray is large when the humidity becomes stable, and is zero at the time of the power-off of the first image forming system 10A. Thus, according to the fifth environment information image 33e, the temperature and humidity and the remaining sheet amount with respect to the capacity of each sheet feed tray can be visualized, so that correlation between the temperature and humidity and the remaining sheet amount can be made clear. Therefore, by extracting a subject of how to use sheets in consideration of influence of changes in temperature and humidity, the user can lead it to improvement in printing operation.

### Display Example of Sixth Environment Information Image 33f

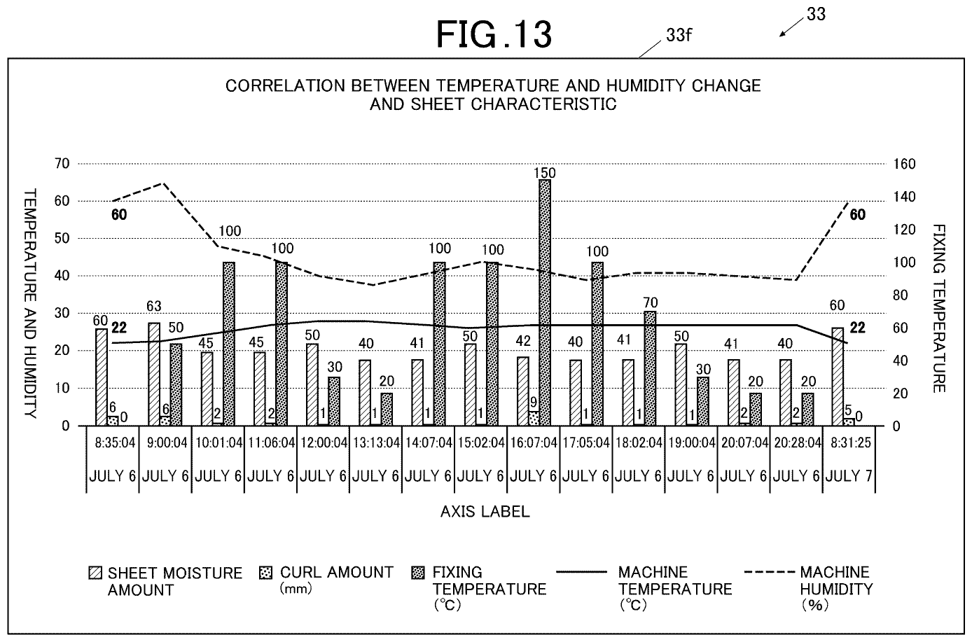

FIG. 13 is a diagram illustrating an example of a sixth environment information image 33f displayed on the display part 33 of the client terminal 30 according to the present embodiment. The management apparatus 40 causes the display part 33 of the client terminal 30 to display, for example, the sixth environment information image 33f based on the environment information, the sheet characteristic information and the like acquired from the first image forming system 10A. In the sixth environment information image 33f, a line chart and a bar chart are displayed that indicate correlation between changes in sheet characteristic including the moisture amount and curl amount of the sheet(s) S, changes in temperature and humidity, and changes in fixing temperature. The horizontal axis of the charts represents time. The horizontal axis of the charts mainly includes a period of July 6, and the period is divided in units of about one hour. The left side of the vertical axis of the charts represents the temperature and humidity, and the right side of the vertical axis thereof represents the fixing temperature. The temperature, humidity and the like in the charts also include changes in the temperature, humidity and the like of the image forming system 10A in the period including the state in which the image forming system 10A is not executing a print job, for example, in the sleep state.

By referring to the sixth environment information image 33f, the user can confirm that the humidity is high and the moisture amount on the sheet S is great during the operation of the first image forming system 10A, for example, between eight o'clock and nine o'clock in summer. Furthermore, the user can also confirm that the curl amount of the sheet S is higher as the moisture amount of the sheets S increases, and that the state of the sheet S has changed. This is considered to be caused by, for example, leaving the sheet S accommodated in the sheet feed tray under a high-humidity environment from the end of the operation of the first image forming system 10A to the time of the operation. In this case, there is a high possibility that an error related to conveyance of the sheet S and an error related to image quality occur. Further, also in a case where cut sheets S are left in a stacked state under a high-humidity environment, the sheets S are moistened, and a failure may occur in the conveyance or finishing of the sheets. On the other hand, although it is not presented in the sixth environment information image 33f, if the sheet S is left in the sheet feed tray in the case of a low humidity, the influence of static charge increases, and overlapping feeding of sheets is likely to occur, which increases the possibility of occurrence of a conveyance error. Thus, according to the sixth environment information image 33f, the sheet characteristic and the temperature and humidity can be visualized, so that the correlation between the sheet characteristic and the temperature and humidity can be made clear. Therefore, it is possible to change the settings and review the printing operation in preparation for an error related to conveyance of the sheet S and an error related to image quality.

### Display Example of Seventh Environment Information Image 33g

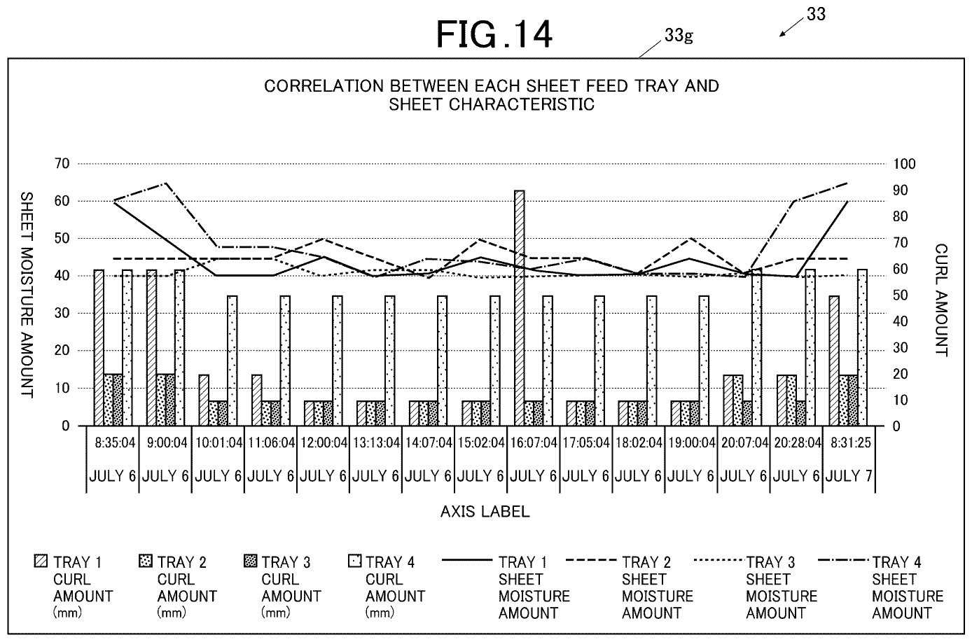

FIG. 14 is a diagram illustrating an example of a seventh environment information image 33g displayed on the display part 33 of the client terminal 30 according to the present embodiment. The management apparatus 40 causes the display part 33 of the client terminal 30 to display, for example, the seventh environment information image 33g based on the environment information, the sheet characteristic information and the like acquired from the first image forming system 10A. In the seventh environment information image 33g, a line chart and a bar chart are displayed that indicate correlation between changes in sheet characteristic including the curl amount and the moisture amount of the sheet(s) S on each of three sheet feed trays and one manual sheet feed tray and changes in the temperature and humidity. The horizontal axis of the charts represents time. The horizontal axis of the charts mainly includes a period of July 6, and the period is divided in units of about one hour. Three sheet feed trays and one manual sheet feed tray are assigned to each of the divided time periods. The left side of the vertical axis of the charts represents the moisture amount of the sheet S, and the right side of the vertical axis thereof represents the curl amount of the sheet S. The temperature, humidity and the like in the charts also include changes in the temperature, humidity and the like of the image forming system 10A in the period including the state in which the image forming system 10A is not executing a print job, for example, in the sleep state.

By referring to the seventh environment information image 33g, the user can confirm that the humidity is high and the moisture amount of the sheet S is great during the operation of the first image forming system 10A, for example, between eight o'clock and nine o'clock in summer. Furthermore, the user can also confirm that the curl amount of the sheet S is higher as the moisture amount of the sheet S increases, and that the state of the sheet S has changed. This is considered to be caused by, for example, leaving the sheet S accommodated in the sheet feed tray under a high-humidity environment from the end of the operation of the first image forming system 10A to the time of the operation. In this case, there is a high possibility that an error related to conveyance of the sheet S and an error related to image quality occur. Further, also in a case where cut sheets S are left in a stacked state under a high-humidity environment, the sheets S are moistened, and a failure may occur in the conveyance or finishing of the sheets. Further, by referring to the seventh environment information image 33g, the user can confirm that the moisture amount and the curl amount of the sheet S fed from the manual sheet feed tray externally attached to the apparatus are high. Thus, according to the seventh environment information image 33g, the sheet characteristic and the temperature and humidity can be visualized, so that the correlation between the sheet characteristic and the temperature and humidity can be made clear. Therefore, it is possible to change the settings and review the printing operation in preparation for an error related to conveyance of the sheet S and an error related to image quality.

As described above, according to the present embodiment, an environment information image visualizing pieces of environment information including the temperature and humidity of the image forming system 10 in the period including the state in which a print job is not being executed in time series is displayed on an external apparatus such as the client terminal 30. Furthermore, in the present embodiment, an environment information image visualizing pieces of the remaining sheet amount information in time series in association with the pieces of the environment information and an environment information image visualizing pieces of the sheet characteristic information in time series in association with the pieces of the environment information are displayed on the display part 33 of the client terminal 30, for example. Thus, the user can determine whether the current printing operation, production workflow, and production external environment are appropriate. As a result, the printing operation and the like can be improved according to the environment condition where the image forming system 10 is placed, and the productivity can be improved by increasing the operation rate of the image forming system 10. In particular, in a print shop or the like that manages a plurality of image forming systems 10, the operation rate of the image forming systems 10 can be increased, and the equipment investment can be recovered at an early stage.

Although one or more preferred embodiments of the present disclosure have been described in detail with reference to the accompanying drawings, the technical scope of the present disclosure is not limited thereto. Furthermore, various modification examples and improved ones naturally belong to the technical scope of the present disclosure within the range of the person in the art's technical ideas described in claims.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A management method that is performed by a management apparatus that manages an image forming apparatus, the management method comprising:
acquiring environment information on the image forming apparatus in a period including a state in which the image forming apparatus is not executing a print job; and
presenting the acquired environment information in time series.

2. The management method according to claim 1, wherein the management apparatus
manages a plurality of image forming apparatuses each being the image forming apparatus,
acquires, for each of the plurality of image forming apparatuses, the environment information on the image forming apparatus in the period including the state in which the image forming apparatus is not executing the print job, and
presents the acquired environment information in time series.

3. The management method according to claim 2, wherein the management apparatus presents the acquired environment information in time series for each of the plurality of image forming apparatuses.

4. The management method according to claim 1, wherein the state in which the image forming apparatus is not executing the print job is a standby state or a sleep state of the image forming apparatus.

5. The management method according to claim 1,
wherein the image forming apparatus includes a sheet feed tray, and
wherein the management apparatus
acquires information on a remaining sheet amount on the sheet feed tray in the period including the state in which the image forming apparatus is not executing the print job, and
presents the acquired information on the remaining sheet amount in time series in association with the environment information.

6. The management method according to claim 1,
wherein the image forming apparatus includes a plurality of sheet feed trays, and
wherein the management apparatus
acquires, for each of the plurality of sheet feed trays, information on a remaining sheet amount in the period including the state in which the image forming apparatus is not executing the print job, and
presents the acquired information on the remaining sheet amount on each of the plurality of sheet feed trays in time series in association with the environment information.

7. The management method according to claim 1,
wherein the image forming apparatus includes a sheet characteristic detector that detects a sheet characteristic, and
wherein the management apparatus
acquires information on a detection result by the sheet characteristic detector in the period including the state in which the image forming apparatus is not executing the print job, and
presents the acquired information on the detection result in time series in association with the environment information.

8. The management method according to claim 1,
wherein the image forming apparatus includes a sheet characteristic detector that detects a sheet characteristic and a plurality of sheet feed trays, and
wherein the management apparatus
acquires, for each of the plurality of sheet feed trays, information on a detection result by the sheet characteristic detector in the period including the state in which the image forming apparatus is not executing the print job, and
presents the acquired information on the detection result on each of the plurality of sheet feed trays in time series in association with the environment information.

9. The management method according to claim 1, wherein the environment information includes at least one of a temperature or a humidity.

10. The management method according to claim 1, wherein the management apparatus presents the environment information that is environment information at a time when a power of the image forming apparatus is turned on or at a time when a predetermined time elapses after the power thereof is turned on.

11. The management method according to claim 1, wherein the management apparatus presents the environment information that is environment information at a time when a power of the image forming apparatus is turned off or at a time that is a predetermined time before the power thereof is turned off.

12. The management method according to claim 1, wherein the management apparatus presents the environment information that is environment information from when a predetermined time elapses after a power of the image forming apparatus is turned on to when the power thereof is turned off.

13. The management method according to claim 1, wherein the management apparatus presents the acquired environment information in time series in a two-dimensional format in which a first axis represents time and a second axis represents information on an environment.

14. The management method according to claim 13,
wherein the first axis is divided in units of a predetermined period, and
wherein the management apparatus presents, along the first axis, a calculation result of the environment information in the predetermined period.

15. A management apparatus comprising a hardware processor that performs the management method according to claim 1.

16. A non-transitory computer-readable storage medium storing a program causing, of a management apparatus that manages an image forming apparatus, a computer to perform the management method according to claim 1.
